(19) United States
(12) Patent Application Publication
(10) Pub. No.: US 2003/0159148 A1
(43) Pub. Date: Aug. 21, 2003

(54) Selective receiver of news items

(75) Inventor: Jean Farineau, Levallois Perret (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/365,476

(22) Filed: Feb. 13, 2003

(30) Foreign Application Priority Data
Feb. 18, 2002 (FR) 02 02 015

(51) Int. Cl. H04N 5/445

(52) U.S. Cl. 725/49; 725/46

(57) ABSTRACT

A receiver receives and selectively presents broadcast news items. Each news item broadcast is allocated a vector representing the news category to which the news item belongs and a pertinence factor representing the pertinence of that item in the category. The receiver includes a filter for selecting news items to be presented by the receiver as a function of a degree of interest profile for each category. The degree of interest of a news item is weighted by the pertinence factor. The receiver further includes a modulator for modulating the pertinence factor allocated to at least some news categories. The modulator for modulating the pertinence factor effects the modulation as a function of data relating to previous consultations of news items in the same category.

### CROSS-REFERENCE TO RELATED APPLICATIONS

This application is based on French Patent Application No. 02 02 015 filed Feb. 18, 2002, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a selective receiver of news items. It relates more particularly to a receiver of the type described in U.S. patent application Ser. No. 296145.

2. Description of the Prior Art

The receiver described in the prior art patent enables the user to record news that is of interest to him without having to program the receiver beforehand.

Programming recordings on a receiver, for example a tape recorder, is difficult.

To this end, according to the prior art patent, prior to broadcasting, news items are classified by the broadcaster into various categories, for example in accordance with a tree structure; each news item is assigned a descriptor characterizing the class to which it belongs and a pertinence factor that represents the interest that the news item might have for users interested in the class, branch or category to which the news item belongs.

In the receiver, each news item to be recorded and presented to the user is selected as a function of a potential interest in that news item defined by a user profile in the receiver. In this way each news item category is allocated a degree of interest.

It is not essential to enter the user's interests into a memory of the receiver at the outset, as they can be determined by a statistical training process.

Accordingly, in one example, the receiver includes a key for moving onto another news item, a key for requesting more details (when the news items are classified by levels of detail), and a record key, and in this case the receiver is programmed to determine the degree of interest of each category as a function of the time spent by the user consulting a news item from that category, for example. More generally, any consultation of a news item increases the degree of interest attached to the category to which that item belongs and any rejection or significantly shortened consultation of a news item reduces its degree of interest.

The receiver is of course adapted to the nature of the news that it is intended to receive. It can therefore be a computer, a radio receiver, a television receiver, a telephone receiver, a personal digital assistant, or an electronic book.

As also described in the prior art patent No. 2809557, because all the news that is of interest to the receiver user can be stored in a memory, broadcasting can take place at a time independent of consultation of the receiver, for example during slack periods such as overnight, which in a telecommunications system means that the transmission network load can be spread out.

In any such method of broadcasting news items it is important for the pertinence factor allocated by the broadcaster to each news item to correspond to the interest that it may arouse in users. This is why, as described in the prior art patent, the consultation of broadcasts stored locally by the user confirms his interest in those broadcasts and validates the pertinence of the classification decided on by the news production units. This confirmation of the interest in the broadcasts can be sent back to the broadcaster to update a pertinence mark of the classifications decided on by the broadcaster's production units; if the classifications proposed by a production unit are confirmed by users, the pertinence mark of the classifications decided on by that production unit can be increased. On a more global level, the average pertinence mark of all transmissions offered by the broadcasting company can constitute a production unit quality criterion and therefore a reliability criterion for potential users.

The invention stems from the observation that the pertinence mark decided on by the broadcaster or the production company is based on a subjective process, which can introduce randomness into the operation of the filter device, especially in the presence of pertinence marks that are systematically too high, causing the inopportune selection of contents that are of only marginal interest, to the detriment of contents whose pertinence is evaluated in a more moderate manner.

The device according to the invention introduces a local correction at the level of the access terminal, automatically moderating the pertinence marks for that particular category for the source of the content concerned, in order to correct grading excesses. The device according to the invention can also provide an indication as to the source of the content (broadcaster or production company) in order to cause it to moderate its grading for the content category concerned. It can further provide for the publication of an overall measurement and a summary of corrections effected locally at the level of each access terminal, in order to inform users as to the quality of the grading applied by each source of content.

To establish the local correction to the pertinence marks relating to the categories concerned, the receiver according to the invention includes, for at least some news categories, means for modifying the pertinence factor allocated by the broadcaster as a function of the interest or lack of interest manifested by the user in each category, means being provided for measuring the interest and the lack of interest according to the mode of operation of the receiver.

For example, in one embodiment, the receiver is adapted to reduce the pertinence factor allocated to news items that are not consulted much or at all when the pertinence factor (supplied by the broadcaster) is high and the interest of the user, as determined automatically by his previous use of the receiver, is also high.

To determine that a news item is not consulted much or at all, means are provided for measuring the time between the appearance of the news item and the operation of a key (or the like) to move on to another news item or to switch off the receiver. For example, if this time is generally less than two seconds, this indicates that the user is not interested in news items in the category concerned.

The pertinence factor can be increased if the user shows a marked interest in the category concerned. For example, if news items are classified by their level of detail and the user repeatedly requests more details for the category concerned, then the receiver increases the pertinence factor allocated to that category. Similarly, the pertinence factor can be increased if the user repeatedly records news items in the category concerned for archival storage. In this case, the receiver is programmed to measure the number of operations of the key for requesting further details and/or the record key, for example, and to increase the pertinence factor allocated to the category as a function of this number.

For these measurements it is sufficient to provide for each of the categories whose pertinence factor can be modified in the receiver an accumulator comprising a memory or a memory space. It is preferably the highest level classes whose pertinence factor can be modified.

### SUMMARY OF THE INVENTION

The invention provides a receiver adapted to receive and to present selectively broadcast news items so that each news item broadcast is allocated a vector representing the news category to which the news item belongs and a pertinence factor representing the pertinence of that item in the category, which receiver includes filter means for selecting news items to be presented by the receiver as a function of a degree of interest profile for each category, the degree of interest of a news item being weighted by the pertinence factor, and modulator means for modulating the pertinence factor allocated to at least some news categories.

The modulator means for modulating the pertinence factor preferably include means for effecting this modulation as a function of data relating to previous consultations of news items in the same category. In this case, in one embodiment, the modulator means for modulating the pertinence factor reduce the pertinence factor each time that a news item in the category concerned is not consulted or only partly consulted. For example, the reduction is directly proportional to the pertinence factor and/or the degree of interest.

One embodiment of the receiver further includes a user interface including a skip key for skipping a news item and means for reducing the pertinence factor as a function of operation of the skip key.

In one embodiment the modulator means for modulating the pertinence factor increase the pertinence factor when a news item belonging to the category to which the pertinence factor relates is stored in memory.

In one embodiment the news items are allocated a level of detail and the modulator means increase the pertinence factor when the user requests a higher level of detail for a consulted news item in the category concerned.

News is preferably classified into categories in a tree structure leading from the general to the particular and modulator means are provided for modulating the pertinence factor for only the highest level category or categories.

One embodiment of the receiver includes means for sending to a central station a coefficient of modulation of the pertinence factor for the category to which the pertinence factor relates.

Another aspect of the invention applies the above receiver to receiving news belonging to the group including sound news and musical recordings, video news and programs, texts, computer programs, files, news data, messages broadcast over the networks, fixed images or sequences of animated images, pages broadcast over a network such as the Internet, catalogs, commercial news, weather bulletins, broadcast software applications and broadcast games.

Other features and advantages of the invention will become apparent from the following description of embodiments of the invention given with reference to the accompanying drawings.

### BRIEF DESCRIPTION OF THE DRAWINGS

FIG. 1 shows a prior art receiver.

FIG. 2 shows a user interface for the FIG. 1 device.

FIGS. 3 and 4 show parts of a receiver according to the invention.

### DETAILED DESCRIPTION OF THE PREFERRED EMBODIMENT

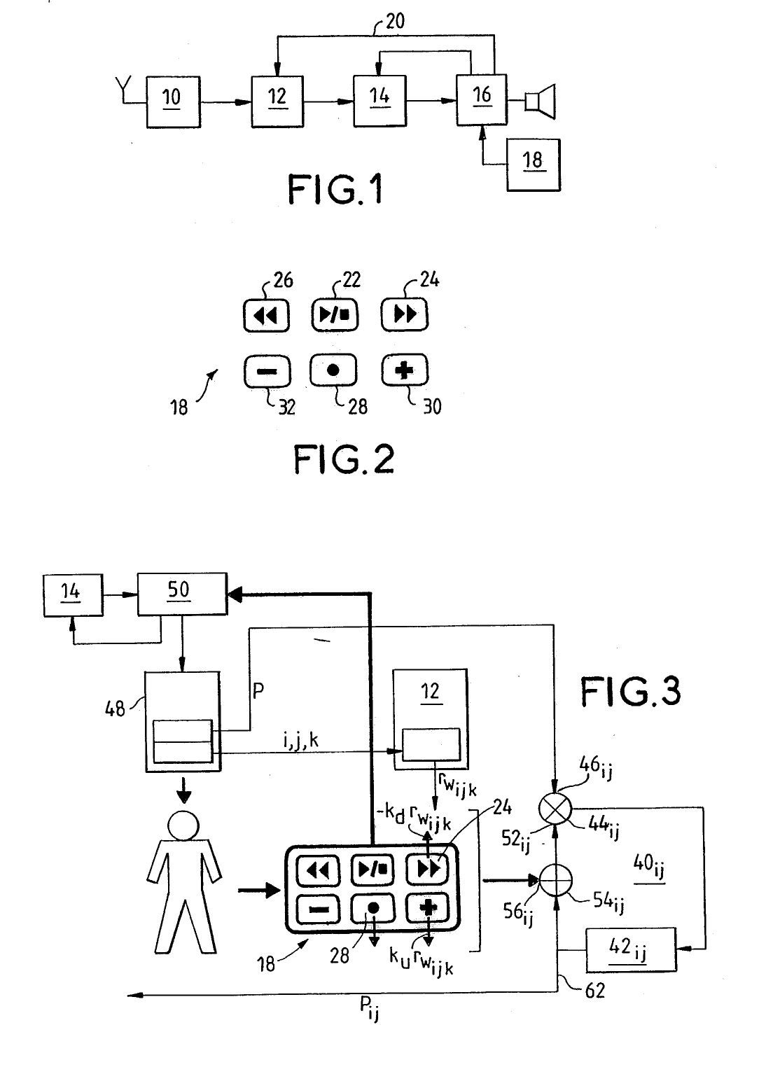

FIG. 1 shows a receiver for receiving data broadcast by the method described in French patent No. 2809557. In this example the data considered is radio data.

The receiver includes a radio receiver unit 10 delivering news items to a filter unit 12 adapted to retain only news items that correspond to a profile of the user. The filtered news items are entered into a cache memory 14 of any type, such as a semiconductor memory or a magnetic disk memory. The data stored is accessible via a presentation unit 16 operated by a user interface 18 which in this example includes six keys, as described below.

The presentation unit 16 also enables broadcasts recorded in the memory and selected via the interface 18 to be listened to.

The filter unit 12 receives news items from the presentation unit 16 over a connection 20 in order to adapt the filtering it applies to suit the interests of the user, as expressed by his operation of the keys of the interface 18.

As described in the prior art patent, the interface 18 includes six keys. There are an on/off key 22 and a skip key 24 for skipping from the current news item to the next item in the classification determined by the filter unit 12. A key 26 returns to previous news items (in the sense of the classification defined by the filter unit 12). A record key 28 provides archive storage of a news item, for example in an area of the memory 14 reserved for archive storage, other news items being deleted from the memory 14 after a predetermined time period or once they have been consulted.

A key 30 marked “+” provides access to a higher level of detail if news is classified by level of detail. Finally, a key 32 marked “−” accesses a less detailed level of presentation. For a radio broadcast, a lower level of detail corresponds to a significantly shorter presentation time per news topic or subject.

To better understand how the present invention improves the receiver, it is necessary to outline here the segmentation of news as described in the prior art patent.

News is segmented in accordance with three levels of detail. In the context of a radio broadcast, the level of detail 1 corresponds to a short news item, known as a “news flash”, with a duration of the order of a few tens of seconds, level 2 to a news item with a duration of a few minutes, and level 3 to broadcasts devoted to a theme and whose duration is at least 15 minutes, for example.

Also, news is classified into a tree structure, i.e. from general classes (or categories) to more specific classes.

For radio broadcasts, for example, the general categories are current affairs, sport, culture, stocks and shares. Each of these general categories is divided into a number of branches, for example politics and the economy in the case of the current affairs category. Each of these branches is in turn divided into a number of second level branches. For example, politics can be divided into national politics and international politics. Finally, in this example, the second level branches can be divided into third level branches. Thus national politics can be divided into miscellaneous, environment, parliament etc.

In this way each news item can be represented by a vector that indicates the rank of the news item in each branch level.

For example, a national news item on the environment can be represented by the vector (2,5,4,9) in which the 2 represents the news class (or category), the 5 represents politics (this is the rank of politics in the first level branches), the 4 represents the rank of national political news in the second level branches, and the 9 represents the rank of national political news relating to the environment in the third level branches.

It is also clear that a news item can be classified in other headings and can therefore be allocated another vector, for example (2,6,2).

Thus each news item is allocated one or more vectors representing its location in the news classification tree. Furthermore, each news item is also allocated a pertinence factor with a value from 0.1 to 10, for example. This factor quantifies the interest that the broadcaster imagines the news item will have for the population interested in the branch concerned. Thus the pertinence factor for the same news item allocated a number of vectors may differ from one vector to another.

Each news item is therefore transmitted with a descriptor which, in this example, includes, in addition to the vectors mentioned above and the pertinence factors, for each vector, a news item identifier, a listening time (in the case of radio news), the space (expressed as a number of bytes) occupied in the memory of the receiver, the level of detail (from 1 to 3), the date and time of production of the news item, its shelf life (i.e. the time after which the item can be deleted from the memory), an introduction threshold and an acquisition threshold.

The introduction threshold is the estimated minimum time for the user to grasp the subject matter of the news item. It is one second, for example. In the receiver, this introduction threshold is used to update the profile stored in memory by the filter unit 12. Operation of the skip key 24 is considered significant only if it occurs in the time period between the introduction threshold (following the start of the presentation of the news item) and a limit value relatively close to the threshold. For example, if the introduction threshold is one second, the user is considered to be showing a lack of interest if he presses the skip key 24 between 1 and 3 seconds after the start of presentation of the item.

The acquisition threshold is the minimum time to consult the news item after which the user may be considered to have grasped the essentials of the item. For example, for a news item lasting 30 seconds, this criterion could be a 15 second consultation, in which case the receiver is programmed to consider the news item to be of interest to the user and to update the filter unit 12.

If the receiver can be used for data other than audio data, the presentation time of the news item varies according to the nature of the news. For a text, for example, this duration will correspond to an estimated reading time.

As described in the prior art patent, in the receiver, the degree of interest allocated to each class and to each branch, i.e. to each vector, is a function not only of the consultation time of each news item but also the number of consultations.

It should be noted at this point that it is essential to distinguish the pertinence factor, which is allocated to each news item by the broadcaster, from the degree of interest inherent to a news category, all such degrees of interest constituting a user profile stored by the filter unit 12. The pertinence factor allocated by the broadcaster relates to an individual news item, whereas the degree of interest relates to a category within the tree structure constituting the user profile, this tree structure being identical to the news classification tree structure.

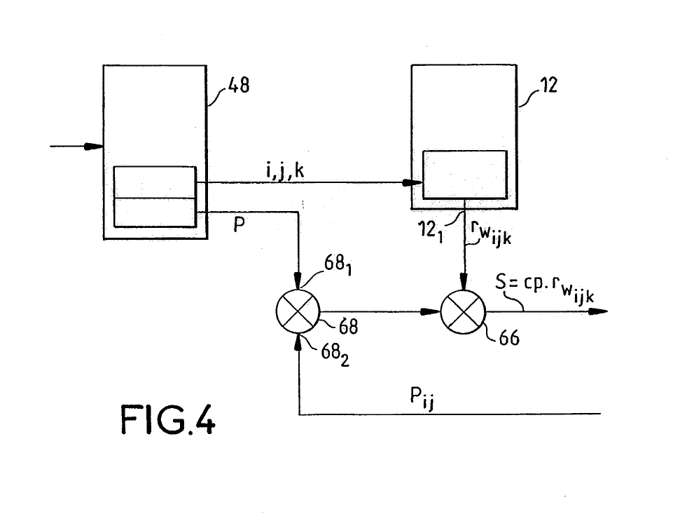

According to an important aspect of the invention described with reference to FIG. 3, each high level branch of the news classification is associated with an accumulator 40ᵢⱼ which includes a register 42ᵢⱼ constituting a reserved memory space, for example, and which is intended to supply a numerical value constituting a coefficient of modulation of the pertinence factor allocated by the broadcaster to each news item. This coefficient depends on the interest shown by the user of the receiver in the category to which the news item concerned belongs. Thus the coefficient of modulation of the pertinence factor can be determined in an analogous manner to that in which the degree of interest in each category, i.e. the profile stored in the filter unit 12, is determined.

The accumulator 40ᵢⱼ also includes a multiplier 44ᵢⱼ having a first input 46ᵢⱼ receiving the pertinence factor p of the item 48 presented by the presentation unit 50. A second input 52ᵢⱼ of the multiplier 44ᵢⱼ receives an output signal from an adder 54ᵢⱼ with a first input connected to the output of the register 42ᵢⱼ and a second input 56ᵢⱼ which receives an increment which is a function of the user's operation of the keys of the interface unit 18.

The coefficient of modulation of the pertinence factor that is stored in the register 42 is determined in the following manner:

Each item 48 presented to the user is allocated a vector or pointer i,j,k which determines the position of that item within the classification tree structure, as well as a pertinence factor p for the item.

The vector i,j,k is applied to the input of the filter unit 12 containing the user profile. This vector is allocated a degree of interest, also referred to as the relative weight (rw) of the class i,j,k of the news item relative to all the other classes. This degree of interest (relative weight) is denoted rwᵢⱼₖ.

The pertinence factor p is applied to the input 46ᵢⱼ.

If the user presses the skip key 24 of the interface 18 to skip to an item after the item currently accessed, a negative pertinence correction is established, with the value −k_{d}.rwᵢⱼₖ. The coefficient k_{d} controls the rate at which the pertinence correction decreases. The factor k_{d} is a fixed factor or is inversely proportional to the time elapsed since the beginning of the presentation of the item, in that early pressing of the skip key 24 indicates a marked lack of interest in the subject matter.

If, conversely, the user presses the key 28 to store the news item or the key 30 to request further details during access to the item concerned, a positive pertinence correction is established, with the value kᵤ.rwᵢⱼₖ. The factor kᵤ is a factor for controlling the rate at which the pertinence correction increases and is fixed, independent of the time at which the key concerned is pressed.

Each pressing of a key 24, 28 or 30 therefore supplies a positive or negative increment fed to the input 56ᵢⱼ and which the multiplier 44ᵢⱼ multiplies by the pertinence factor p, in order to weight the correction by the pertinence decided on by the broadcaster: the greater the broadcaster's assessment error, the more significant the correction.

The result of the multiplication, i.e. −p.k_{d}rwᵢⱼₖ or +p.kᵤrwᵢⱼₖ, is accumulated in the register 42ᵢⱼ.

For simplicity, the registers are allocated to only the first two levels of the tree. Thus a register is provided for each level 1 category and a register for each level 2 category. Thus a category of level 3 or above in the tree is associated with the highest level category, i.e. the level 2 to which it is attached. For example, an item classified (5,1,2,1,5) is accumulated in the class (5,1,2).

In the above example:

Rᵢⱼ[n]=Pᵢⱼ[n−1]−p.k_{d}.rwᵢⱼₖ, or

Pᵢⱼ[n]=Pᵢⱼ[n−1]+p.kᵤ.rwᵢⱼₖ.

As an alternative to this, registers can be used for each tree level or, conversely, accumulators can be used only for level 1.

The correction process operates in a statistical manner: the correction is negligible for the first few times items are accessed. However, thanks to the accumulation process established for each main class of information, systematic evaluation errors are eventually reflected in significant corrections, which can significantly reduce the broadcaster's evaluation for the class of news concerned.

By the same principle, systematic classification errors are corrected by moderating the pertinence factor attached to the classification vector.

In the example, the factors Pᵢⱼ are transmitted to the broadcaster (link 62). These factors Pᵢⱼ constitute a quality indicator as to the accuracy of the classification of news and the pertinence allocated by each of the broadcaster's editorial teams to each news item.

The coefficients of modulation (modulated factors) Pᵢⱼ are used in the receiver to weight the degree of interest presented by each category and therefore to determine the news items stored in memory and the order of presentation of the stored items.

To determine the news items to be stored in memory and presented, each item is allocated a score which is the product of the pertinence factor by the degree of interest of the class.

Thus the score S for each item has the following value:

S=cp.rwᵢⱼₖ

where: cp=p.Pᵢⱼ

In the above equations, cp is the corrected pertinence factor (see above) and rwᵢⱼₖ is the relative weight (degree of interest) of the class i,j,k, supplied by the filter unit containing the user profile.

FIG. 4 shows an embodiment corresponding to the above description:

The broadcast item 48 includes a vector i,j,k which is applied to the filter unit 12 which supplies at its output 12 the relative weight rwᵢⱼₖ which is fed to the first input of the multiplier 66 whose second input receives the output of a second multiplier 68. The first input 68₁ of the multiplier 68 receives the pertinence factor p from the broadcast item 48 and its second input 68₂ receives the coefficient Pᵢⱼ supplied by the output of the register 42ᵢⱼ (FIG. 3). The output of the first multiplier 66 supplies the score S corresponding to the above formula.

The items to be stored in the cache 14 or presented spontaneously to the user during consultation are selected by decreasing score order. The more significant the pertinence correction, the more the score of the element is modified, thereby leading, in the case of a reduction of pertinence, to no storage or no spontaneous presentation to the user.

There is claimed:

1. A receiver adapted to receive and to present selectively broadcast news items so that each news item broadcast is allocated a vector representing the news category to which the news item belongs and a pertinence factor representing the pertinence of that item in the category, which receiver includes filter means for selecting news items to be presented by said receiver as a function of a degree of interest profile for each category, the degree of interest of a news item being weighted by said pertinence factor, and modulator means for modulating said pertinence factor allocated to at least some news categories.

2. The receiver claimed in claim 1 wherein said modulator means for modulating said pertinence factor include means for effecting this modulation as a function of data relating to previous consultations of news items in the same category.

3. The receiver claimed in claim 2 wherein said modulator means for modulating said pertinence factor reduce said pertinence factor each time that a news item in the category concerned is not consulted or only partly consulted.

4. The receiver claimed in claim 3 wherein said reduction is directly proportional to said pertinence factor and/or said degree of interest.

5. The receiver claimed in claim 3, further including a user interface including a skip key for skipping a news item and means for reducing said pertinence factor as a function of operation of said skip key.

6. The receiver claimed in claim 2 wherein said modulator means for modulating said pertinence factor increase said pertinence factor when a news item belonging to the category to which said pertinence factor relates is stored in memory.

7. The receiver claimed in claim 2 wherein said news items are allocated a level of detail and said modulator means increase said pertinence factor when the user requests a higher level of detail for a consulted news item in the category concerned.

8. The receiver claimed in claim 1 wherein news is classified into categories in a tree structure leading from the general to the particular and modulator means are provided for modulating the pertinence factor for only the highest level category or categories.

9. The receiver claimed in claim 1, further including means for sending to a central station a coefficient of modulation of the pertinence factor for the category to which said pertinence factor relates.

10. Application of a receiver as claimed in claim 1 to receiving news belonging to the group including sound news and musical recordings, video news and programs, texts, computer programs, files, news data, messages broadcast over the networks, fixed images or sequences of animated images, pages broadcast over a network such as the Internet, catalogs, commercial news, weather bulletins, broadcast software applications and broadcast games.
